(19) United States
(12) Patent Application Publication
(10) Pub. No.: US 2003/0230372 A1
(43) Pub. Date: Dec. 18, 2003

(54) Method for placing objects on the inner wall of a placed sewer pipe and device for carrying out said method

(76) Inventor: Kurt Schmidt, Gruningen (CH)

Correspondence Address: OLIFF & BERRIDGE, Post Office Box 19928, Alexandria, VA, 22320, US

(21) Appl. No.: 10/362,427

(22) PCT Filed: Jun. 13, 2002
(86) PCT No.: PCT/CH02/00323

(51) Int. Cl. B32B 31/00; F16L 55/26

(52) U.S. Cl. 156/64; 156/71; 156/378; 104/138.2

(57) ABSTRACT

The invention relates to a method and to a device for fastening at least one pipe and/or at least one empty duct (2) on the inner wall (3) of a placed sewer pipe (4). The inventive method is characterized by introducing the at least one pipe and/or empty duct (2) into the sewer pipe, pressing it against the inner wall of the sewer pipe and fastening it by using an adhesive compound (22). The at least one pipe and/or empty duct (2) is guided towards the inner wall (3) in the longitudinal and transverse direction of the sewer pipe (4) in a controlled manner and the object (2) to be placed is included between the inner wall (3) and an inliner (14). The inventive device is characterized by an adjustable guide device (5) that is, according to a preferred embodiment, provided with a swan-neck-shaped, rotatable or swivelable guide element (6).

The invention relates to a method for laying objects to be laid, in particular at least one line and/or an empty pipe, on the inside wall of a laid conduit pipe according to the precharacterizing clause of patent claim 1 and to a device for carrying out such a method having the features of patent claim 12.

It is known for laying new data transmission lines to use an already existing system of conduits, such as for example a sewer system or a gas pipeline system.

It is known furthermore to use for the renewal of conduits what are known as inliners, that is inner linings in the form of a flexible plastic tube. In this case, a ready-made carrier material impregnated with synthetic resin in tube form, for example a tube of woven or nonwoven fabric, is pressed against the inside wall under pressure. In the case of what is known as in-situ molding methods, a flexible needlefelt tube impregnated with synthetic resin is introduced into the conduit to be renewed by means of water or compressed air by the inversion method and is pressed against the inside wall of the conduit. Following inversion, the resin is located on the outer side of the tube, where it bonds with the inside wall of the conduit when it cures. In the region of branches, the inliner must be cut open in such a way as to reconnect the branch pipe to the conduit pipe to allow flow.

In WO 99/65129 and WO 00/06843 it is proposed to combine the laying of data transmission cables with the renewal of the system of conduits. WO 99/65129 proposes for this purpose pushing a tubular inliner into the laid conduit pipe, at least one flexible empty pipe and/or a line being arranged on the outer surface of the said inliner. The inliner, in a folded-together state, is drawn into the conduit pipe together with the object to be laid, the object to be laid being located on the upper side of the folded-together tube. The disadvantage of this is that, when the tube expands, there is no possibility of guiding the object to be laid to a specific point of the inside wall of the conduit pipe. Therefore, in cases in which the inliner is subsequently to be cut open in the region of the junction of branching pipes, there is the risk of the empty pipe and/or the line also being severed at the same time.

In the case of the method according to WO 00/06843, a protective tube receiving a data transmission cable is placed either into a protective strip or into a lining liner, the protective strip or the liner is impregnated with a resin forming a matrix and subsequently introduced into the conduit pipe. There, the liner or an expanding tube is expanded until it is flush against the inside wall. Once the matrix has been cured, the expanding tube is removed. The placing of the object to be laid into the inliner has the disadvantage that the position of the object to be laid can only be controlled with difficulty, or not at all. The other variant has the disadvantage that the protective strip impregnated with the adhesive composition must be handled by the laying robot.

A method according to the precharacterizing clause of claim 1 is known from DE-A 198 61 090. In this case, an object to be laid, for example lines of all types, in particular electrical and/or fiber-optic cables, or empty pipes for such lines, is laid in a conduit pipe by a laying robot which can travel in the conduit and is fastened to the inside wall of the latter. By means of a monitoring device, the operator at the control console can determine the optimum laying line and control the robot in such a way that the object to be laid is fastened to the wall along this line in a bed made for this very purpose, for example by adhesive attachment, setting anchors or fastening with clips. The method is relatively complex, since the laying robot must have not only a controllable guiding device but also devices for fastening the object to be laid. To establish an adhesive bond, the laying robot has, for example, a pretreatment tool for pretreating the wall, an adhesive-bed application device and a pressing device.

Similar methods using controllable laying robots are known from DE-A 199 40 474 and DE-A 197 52 424. In this case, the object to be laid is fastened to the inside wall of the conduit by the laying robot itself.

The invention is therefore based on the object of providing a method of the type specified at the beginning by which the object to be laid can be attached in the conduit pipe with reduced expenditure on apparatus. The invention is also based on the object of providing a device for carrying out such a method.

This object is achieved on the method side by a method having the features of patent claim 1 and on the device side by a device having the features of patent claim 12. Advantageous developments are the subject of the respective subclaims.

According to the invention, the object to be laid, in particular at least one line and/or an empty pipe or a carrier band with at least one integrated line and/or an empty pipe, is guided to the inside wall in a controlled manner in the longitudinal and transverse directions of the conduit pipe. As a result, it is adhesive composition cures. This avoids mechanical overloading of the object to be laid on account of different thermal expansion of the wall and of the carrier band or of the object to be laid. This can occur if the two components are firmly connected to each other. This is feasible by suitable choice of the process parameters, for example the type and amount of adhesive, the pressure when inflating the inliner, the nature of the carrier band, in such a way that the carrier band is impregnated largely completely with adhesive composition but no adhesive bond with the inside wall is produced. Furthermore, a carrier band which is impermeable to the adhesive composition, at least on its side facing the inside wall, for example in that it has an impermeable layer there, is of advantage.

At a branch, the object to be laid is preferably taken a little way along the branch pipe, led circumferentially along the branch pipe, and back again or down to the conduit pipe. As a result, the object to be laid is constantly in contact with an inside wall, to be precise with the inside wall of the conduit pipe or with the inside wall of the branch pipe. Consequently, damage to or even tearing away of the object to be laid as a result of the flowing medium and/or entrained solids is largely ruled out.

As an alternative, the object to be laid is preferably taken past the branch pipe to the right or left. Consequently, the object to be laid is completely outside the flow cross section of the branch pipe and is consequently protected from the medium flowing from the branch pipe into the conduit pipe. Moreover, as in the first-mentioned case, in this case it is not necessary to feed forward a relatively great length of the line or the empty pipe to bridge the branch pipe.

The guiding device is preferably remotely controllable by means of a monitoring device in the form of at least one camera, for example a video camera. Consequently, the device according to the invention can be used particularly advantageously in pipelines which cannot be accessed on foot, such as for example sewer pipes. With the aid of the monitoring device, the position and form of branches can be determined in advance and the guiding device can be controlled in dependence on the result determined.

The monitoring device preferably has a camera in the working direction and a camera counter to the working direction. This makes it possible to observe the conduit pipe on the one hand in the direction of advancement with respect to any branches occurring and on the other hand counter to the working direction or direction of advancement, in particular with respect to the line or empty pipe specifically attached by means of the guiding device and/or the distance from the inliner. As a result, it is possible to react in good time to branches and for the object which is to be laid to be laid in such a way that there is constant intimate contact with the inside wall.

According to a preferred development, the guiding device has a guiding element which can pivot or swivel and directs the object to be laid in a slide-like manner tangentially to the inside wall of the conduit pipe or a branch pipe. This provides a simple possibility for transferring the line or the pipe into the region of that point at which the line or the pipe is to be fastened to the inside wall of the conduit pipe. The guiding element preferably runs from the center point of the conduit to the inside wall, it approaching the inside wall tangentially. It is preferably shaped in such a way that it projects beyond the installation carriage counter to the direction of advancement. For example, it is shaped in the form of a swan's neck. The advantage is that the installation carriage can assume a sufficiently great distance from the inliner, while the front end of the guiding element is in direct spatial proximity to the inliner.

The guiding device is preferably fastened, if appropriate together with the monitoring device, to an installation carriage which can travel in the conduit pipe. A conduit robot as described in WO 99/43063, which is equipped with a suitable guiding device, may be used for example as the installation carriage. The installation carriage preferably has a central lead-through for the object to be laid. This makes a large swiveling or pivoting range of up to 360° possible. However, constructions without a central lead-through are also conceivable, for example with a slide-like guiding element running above the carriage. An installation carriage can easily be made to travel along the conduit pipe, it being possible for this movement of the installation carriage to take place of its own accord by means of a drive of its own or indirectly, for example by shunting. The installation carriage has the effect that the guiding device is securely positioned in the conduit pipe and is movable in the longitudinal direction of the conduit pipe. The central lead-through makes it possible to conduct the line or empty pipe, which is already located in the working direction in the conduit pipe, to the guiding device in a space-saving manner.

To maintain the distance from the inliner, fastened to the installation carriage, for example underneath the guiding device, is a spacer, against which the inliner butts with its front side. The guiding device projects beyond the installation carriage on the rear side of the latter, directed counter to the working direction, approximately as far as the spacer. Consequently, the inliner can also serve for the traveling of the installation carriage, so that there is no need for the installation carriage to have a drive of its own or an existing drive can be switched off. It is also possible, however, for the installation carriage with the guiding device to be provided with a drive motor of its own. The spacer serves the purpose of ensuring the necessary freedom of movement for the guiding device, so that the latter cannot come into direct contact with the inliner. Consequently, it is only possible for a force from the inliner to act indirectly on the guiding device, that is via the installation carriage.

According to an advantageous development of the invention, the adhesive composition is a sewage-resistant synthetic resin, preferably an epoxy resin, polyester resin or vinyl ester resin.

Synthetic resins of this type are readily available on the market and are chemically adequately resistant.

According to a particularly preferred development of the invention, the adhesive composition is located on the outer side of the inliner. This makes it possible to impregnate the carrier band in such a way that it subsequently adheres to the outside wall of the inliner. It is also advantageous in this case that the carrier band is only provided with the adhesive composition shortly before it comes into contact with the inside wall of the conduit pipe. It is consequently possible for the carrier to be readily reeled up and unreeled. In addition, it is automatically impregnated during laying by the adhesive composition located on the outer side of the inliner, so that a separate device for applying the adhesive composition to the carrier band and/or prior impregnation of the carrier band is not required.

Exemplary embodiments of the subject matter of the invention are explained in more detail below on the basis of the drawing, in which schematically:

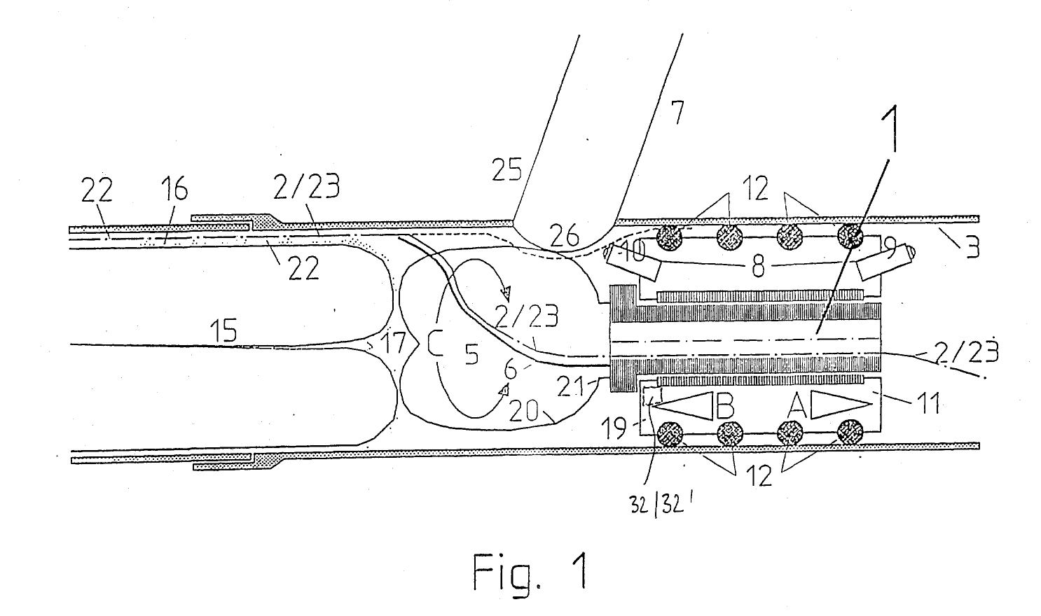

FIG. 1 shows a partly sectioned side view of a device for laying an object to be laid on the inside wall of a laid conduit pipe;

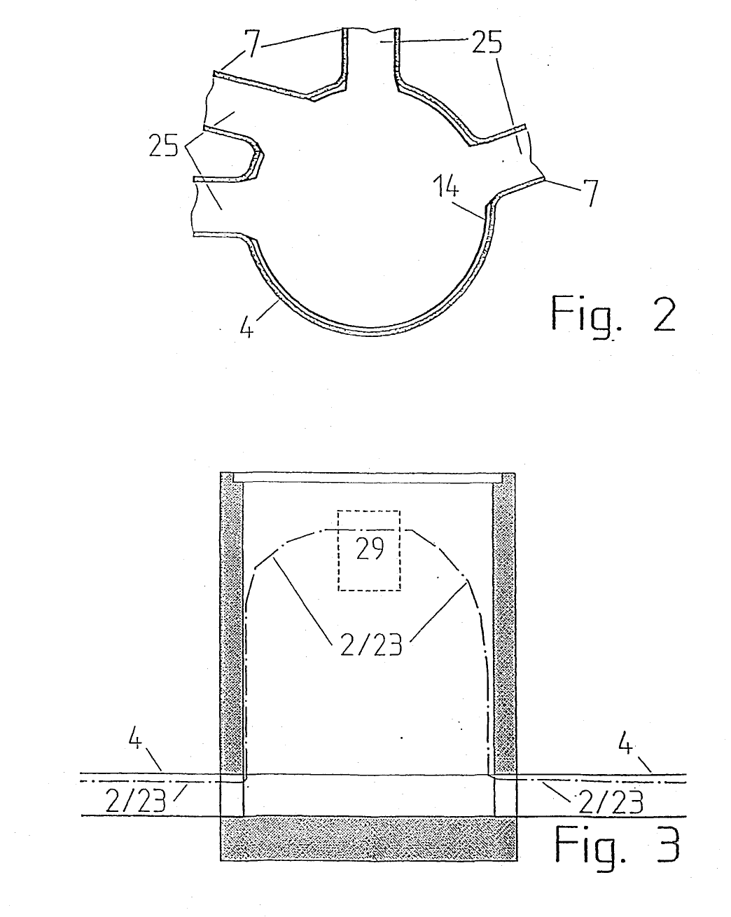

FIG. 2 shows a cross section through a conduit pipe lined with an inliner, with a number of branches;

FIG. 3 shows a partly sectioned side view of an object to be laid, laid according to a first embodiment;

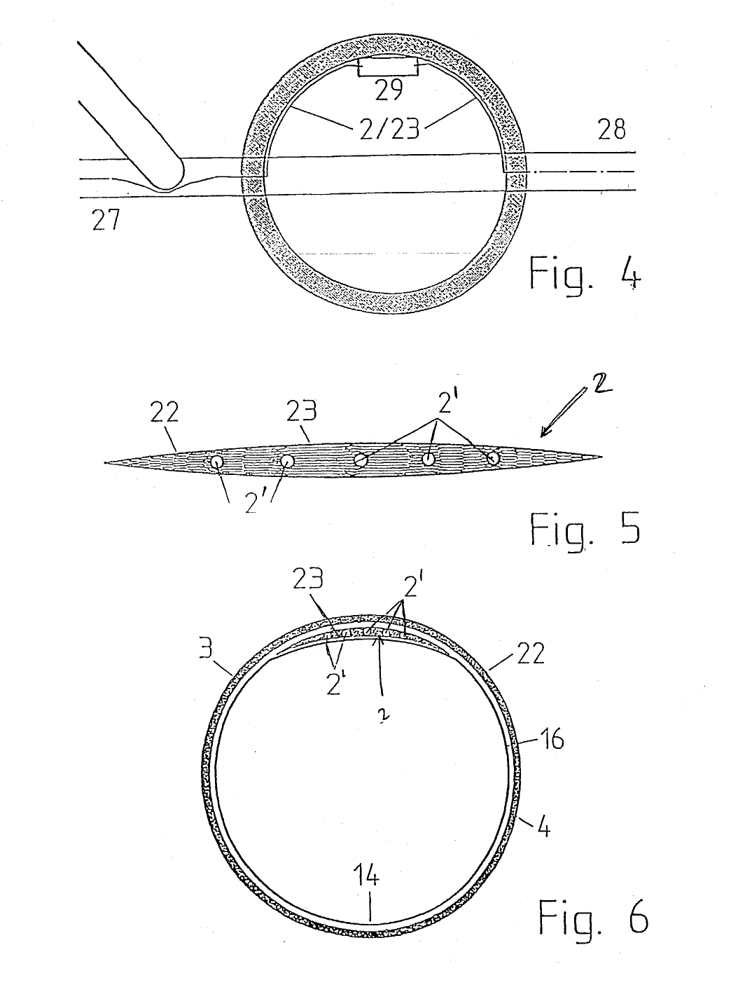

FIG. 4 shows a plan view approximately of the arrangement according to FIG. 3;

FIG. 5 shows a cross section through a carrier band loaded with a number of lines and/or empty pipes;

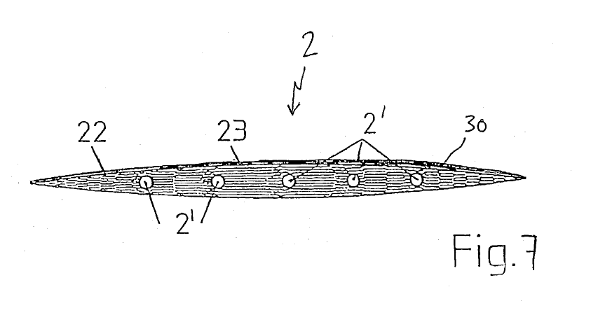

FIG. 6 shows a cross section through a conduit pipe provided with the carrier band according to FIG. 5 and an inliner;

FIG. 7 shows a further carrier band in cross section.

Shown in a partly vertical longitudinal section in FIG. 1 is a device 1 for laying an object to be laid 2 on an inside wall 3 of a conduit pipe 4 already laid in the ground. The object to be laid 2, which preferably comprises lines or an empty pipes 2′ integrated in a carrier band 23, is arranged between an inliner 14 and the inside wall 3 of the pipe.

The device 1 has an adjustable guiding device 5, by means of which the laying of the object to be laid 2 can be specifically controlled in the longitudinal and transverse directions of the conduit pipe 4. According to the embodiment shown in FIG. 1, the guiding device 5 has a swanneck guiding element 6, which can be pivoted or swiveled and directs the at least one line and/or the empty pipe 2 in a slide-like manner tangentially to the inside wall 3 of the conduit pipe 4 or, as also shown later, a branch pipe 7.

The guiding device 5 can be remotely controlled by means of a monitoring device 8. In the present case, the monitoring device 8 comprises two cameras 9, 10, for example television or video cameras. A first camera 9 is provided in the working direction according to arrow A and a second camera 10 is provided counter to the working direction according to arrow B.

The guiding device 5 and the monitoring device 8 are fastened to an installation carriage 11, which is able to travel in the conduit pipe 4 by means of a number of wheels 12, which may be located on the bottom side of the installation carriage or else on its upper side. The installation carriage 11 may have more than two wheels 12 on its bottom and more than one wheel 12 or else no wheel 12 on its upper side. It is possible to press the wheels 12 provided on the upper side of the installation carriage 11 against the inside wall 3 of the conduit pipe 4 by means of springs, in order to make the running of the installation carriage 11 smoother. The installation carriage 11 may be formed with a drive device of its own (not shown) or else, according to a preferred embodiment of the invention, without a drive device of its own.

As also shown in FIG. 1, the installation carriage 11 has a central lead-through 13 for the object to be laid 2. The central lead-through 13 is represented on a greatly enlarged scale in FIG. 1 for the sake of better overall clarity and, according to another embodiment, may also be inclined or formed with rounded, front and rear portions. In this case, the front portion of the installation carriage in the working direction (see arrow A) may, for example, be curved or rounded downward and the opposite, rear portion of the installation carriage may, for example, be curved or rounded upward.

In the working direction A, the guiding device 5 is located on the rear side of the installation carriage 11 ahead of an inliner 14, which is formed as an inner lining for the conduit pipe 4 in the form of a flexible plastic tube. The inliner 14 moves through the conduit pipe 4 in the working direction A by inverting, by means of a pressure medium (not shown in any more detail), such as for example by water pressure or by air pressure. In this case, the inwardly drawn side 15 of the inliner 14 progressively comes to the outside and ultimately forms the outer side 16 of the inliner 14. The outer side 16 then lies completely against the inside wall 3 of the conduit pipe 4. During its movement through the conduit pipe, the inliner 14 accepts from its front side 17 new portions to be laid of the object to be laid 2 and, as shown in the region 18 in FIG. 1, presses them against the inside wall 3 of the conduit pipe 4. In the region 18, the object to be laid 2 is consequently located in the annular gap between the inliner 14 and the inside wall 3 of the conduit pipe 4, in FIG. 1 near the upper apex of the conduit pipe 4.

The guiding device 5 projects with its guiding element 6 beyond the installation carriage 11 on the rear side 19 of the latter, directed counter to the working direction (see arrow B), i.e. in the direction of the inliner 14. Fastened to the installation carriage 11 underneath the guiding device 5 is a spacer 20, which is preferably shaped in a basket-like manner and against which the inliner 14 butts with its front side 17. In this case, the installation carriage is made to travel in the working direction A. The length of the spacer 20, measured in the direction of the conduit, substantially corresponds to the length by which the guiding element 6 projects beyond the installation carriage 11.

As an alternative to the spacer 20, depicted by dashed lines in FIG. 1, the guiding device 5 or the installation carriage 11 may have a control device 32, with which the distance from the inliner is set. This device comprises, for example, a distance sensor 32′, the signal of which serves for controlling the drive of the installation carriage.

The swanneck guiding element 6 of the guiding device 5 is mounted on the rear side 19 of the installation carriage 11, for example by means of a pivot joint 21 (only schematically indicated in FIG. 1). With a corresponding rotary drive, specific control of the object to be laid 2 in the longitudinal and transverse directions of the conduit pipe is possible by swivelling or pivoting the guiding element 6. The pivoting movement of the guiding element 6 is indicated by the double-headed arrow C.

According to a preferred embodiment of the invention, the object to be laid 2 comprises a flexible carrier band 23, which can absorb adhesive composition 22 and is, for example, a woven felt band or a stitched-around knitted fabric. Integrated into this is at least one line or an empty pipe 2′. A cross section through such an object to be laid 2 is schematically shown in FIG. 5 with five lines and/or empty pipes 2′ led parallel to one another. The carrier band 23 may be impregnated by the adhesive composition 22. In this case, however, preferably no unreleasable connection of the carrier band 23 to the inside wall 3 is produced. As shown in FIG. 7, for this purpose the carrier band 23 may be provided on its side intended for lying against the inside wall 3 with a layer 30 which is impermeable to the adhesive composition 22, for example a film.

The adhesive composition 22 is, for example, a water-repellent synthetic resin, preferably an epoxy resin, polyester resin or vinyl ester resin.

As indicated in FIG. 1, the adhesive composition 22 is located on the outer side 16 of the inverted inliner 4, so that the carrier band 23 only comes into contact with the adhesive composition 22 when it enters the gap between the inliner 14 and the inside wall 3 of the conduit pipe 4. It conversely follows from this that the carrier band 23 is not provided with the adhesive composition 22 in the region of the guiding device 5 and the installation carriage 11. It can therefore be handled more easily, the guiding device 5 is not soiled, and there is no need for a device for applying the adhesive composition.

The distance between the guiding element 6 and the inliner 14 is preferably chosen such that the carrier band 23 does not sag.

In the finished state of installation, the cross section schematically represented in FIG. 6 is obtained. After that, the carrier band 23 with the lines and/or empty pipes 2 is located in the region of the upper apex of the conduit pipe 4 between the inside wall 3 of the conduit pipe and the outer side 16 of the inliner 14. The annular gap 24 between the outer side 16 of the inliner 14 and the inside wall 3 of the conduit pipe 4 is completely filled with the adhesive composition 22.

The method according to the invention is explained in more detail below.

The object to be laid 2 is introduced into the conduit pipe 4, provided with an adhesive composition 22 by the inliner 14, pressed radially against the inside wall 3 of the conduit pipe 4 and fastened there in this way. Before being enclosed between the inside wall 3 and the inliner 14, the object to be laid 2 is guided to the inside wall 3 in a controlled manner in the longitudinal and transverse directions of the conduit pipe 4.

At a branch 25, the at least one line and/or the empty pipe 2 is taken a little way along the branch pipe 7, led circumferentially along the branch pipe 7, and back again or down to the conduit pipe 4. In FIG. 2, a number of branches 25 opening into the conduit pipe 4 are represented, the inliner 14 being located in the conduit pipe 4. This is schematically indicated in FIGS. 3 and 4. After that, the object to be laid 2 or the carrier band 23 with the integrated object to be laid 2 is located in the region of the upper apex on the inside wall of the conduit pipe 4, as shown in the left-hand part of FIG. 3, that is still ahead of the branch 25. In the region of the opening point 26, the carrier band 23 is initially taken a little way along up into the branch pipe 7 and then circumferentially along the inside wall of the branch pipe. Finally, on the right-hand side of the branch pipe 7 in FIG. 3, the carrier band 23 is taken back down and into the conduit pipe 4.

The dashed path 27 of the carrier band 23 shown to the left of the branch pipe 7 in the plan view according to FIG. 4 corresponds in this case to the left-hand part of FIG. 3, i.e. that portion of the carrier band 23 which is still located ahead of the branch pipe 7. Similarly, the right-hand dashed path 28 in FIG. 4 corresponds to the right-hand region in FIG. 3, in which the carrier band 23 is located in the conduit pipe 4 again after passing through the branch pipe 7. The part of the carrier band 23 taken circumferentially along the inside wall of the branch pipe 4 is represented in FIG. 4 by solid lines. Approximately at the center in the branch pipe 7, a branching box 29 is provided and attached to the inside wall of the branch pipe 7.

As an alternative, at a branch 25, the object to be laid 2 may be taken to the right or left past the branch pipe 7. This is represented by dash-dotted lines in FIG. 4. The carrier band 23 or object to be laid 2 taken past in this way is consequently fastened to the conduit pipe 4 outside the region of the opening point 26. In the case of all laying operations, it should be ensured that the object to be laid 2 is not buckled.

As shown in FIG. 1, the inliner 14, acted on by a pressure medium not shown in any more detail, butts against the spacer of the installation carriage 11, so that the latter moves steadily or portion by portion in the working direction A. In this case, the carrier band 23 or the at least one line and/or the empty pipe 2 is gradually led through the central lead-through 13 of the installation carriage 11 via the swanneck, pivotable guiding element 6 of the guiding device 5 to the radially outer-lying region of the conduit pipe 4, i.e. into the region of the annular gap 24 between the inliner 14 and the conduit pipe 4, the outer end of the guiding element 6, located near the front side 17 of the inliner 14, running out approximately tangentially with respect to the inside wall of the conduit pipe 4.

If a branch 25 is detected by the monitoring device 8, the guide element 6 is specifically controlled in the region of the opening point 26 in such a way that the carrier band or the object to be laid 2 is preferably taken around the branch 25, as represented in FIG. 4. In order not to allow the bending radius to go below the permissible limit, changes in direction are commenced in good time ahead of the branch 25. For this purpose, the swanneck guiding element 6 is swiveled in the direction of the double-headed arrow D, it being possible for the guiding element 6 to have a radially outwardly open U profile, not shown in any more detail in FIG. 1, for better guidance of the carrier band or object to be laid. Consequently, the carrier band or object to be laid is not within the cross section of the branch pipe under any operating conditions, and is consequently securely fastened to the inside wall of the conduit pipe or to the inside wall of the branch pipe.

If desired, the carrier band 23 or object to be laid 2 may also be laid at some other point than in the region of the upper apex of the conduit pipe 4. Such an attachment is also readily possible by means of the adjustable guiding device 5.

Inliners 14 for conduit pipes, in particular for sewers, have, for example, a diameter of between 100 and 1500 mm. The standard length of such an inliner is approximately 200-400 m. The spacer 20 serves the purpose of avoiding direct contact between the inliner 14 and the guiding device 5. Provided that the installation carriage 11 is not made to travel by means of an inliner 14, it is also possible to dispense with the spacer 20. In this case, a distance setting preferably takes place by means of a suitable control device 32, which comprises, for example, a sensor 32′. Usually, the carrier band 23 is kept vertically upward by means of the swanneck guiding element 6 of the guiding device 5, so that it can be attached safely in the dry zone of the conduit pipe 4 to the inside wall 3 of the latter. In the region of a branch 25, the carrier band 23 is then guided in such a way that it is is not pressed by the inliner 14 into the free cross section of the branch pipe concerned. For this purpose, as explained above, the swanneck guiding element 6 will perform a small swiveling action.

In the case of the laying represented by solid lines in FIG. 4, there is the possibility of at least partly cutting open the carrier band 23 with the lines and/or empty pipes 2′ at the branch pipe 25, which leads for example to a newly built house, and installing there a branching box 29 for future telecommunication cables, for example. The telecommunication cables can be led to the new house through the branch pipe.

The laying and fastening of the object to be laid 2 according to the invention makes it possible to control the pivoting angle of the guiding element 6 during laying in such a way that the object to be laid 2 is taken past the branch pipes. This may take place, for example, at the press of a button by means of a remote control, by ensuring precisely by how many degrees the guiding element 5 must pivot. It is also possible to lay the object to be laid 2 to the side, for example level with the lateral convexity of the conduit pipe, or at the bottom in the conduit pipe. Furthermore, part of the installation carriage 11 together with the guiding device 5 may also be pivotably formed, for example in that an inner part or head of the installation carriage is pivotable, in order to allow the carrier band also to be laid at the bottom in the conduit pipe.

According to a particularly preferred embodiment of the invention, this pivoting is simultaneously registered by the computer in the land register plan, so that, at a later point in time, it is recorded exactly where the carrier band is located in the main conduit. If, at a later point in time, a sewer connection is to be installed for an additional house, the sewer is not cut open precisely at that point where the carrier band was previously laid. Consequently, destruction of the carrier band by sewer work is largely ruled out. The carrier band is, for example, also suitable for receiving fiber-optic cables. A robot vehicle known from the prior art may also be used as the installation carriage, this vehicle being provided with the guiding device according to the invention in place of the customary working head.

1. A method for laying objects to be laid (2) on the inside wall (3) of a laid conduit pipe (4), in which method the object to be laid (2) is introduced into the conduit pipe (4), guided by means of a guiding device (5) to the inside wall (3) in a controlled manner in the longitudinal and transverse directions of the conduit pipe (4), pressed radially against the inside wall (3) of the conduit pipe (4) and fastened there using an adhesive composition (22), characterized in that the object to be laid (2) is enclosed between the inside wall (3) and an inliner (14).

2. The method as claimed in claim 1, characterized in that, in the working direction (A), the guiding device (5) is located ahead of the inliner (14), which moves through the conduit pipe (4) in the working direction (A) by inverting, by means of a pressure medium, and as it does so accepts from the front side (17) new portions to be laid of the object to be laid (2) and presses them against the inside wall (3) of the conduit pipe (4).

3. The method as claimed in claim 1 or 2, characterized in that the guiding device (5) is moved in such a way that it maintains a defined minimum distance from the inliner (14) during laying.

4. The method as claimed in claim 3, characterized in that the minimum distance is maintained by means of a spacer (20) which is coupled with the guiding device (5) and against which the inliner (14) butts during its movement and moves the guiding device (5) in the working direction (A).

5. The method as claimed in claim 3, characterized in that the minimum distance is maintained by means of a control device, which measures the distance from the inliner (14) and initiates a corresponding movement of the guiding device (5).

6. The method as claimed in one of the preceding claims, characterized in that the object to be laid (2) comprises a carrier band (23) in which at least one line and/or an empty pipe (2′) is integrated.

7. The method as claimed in claim 6, characterized in that an unreleasable connection is established between the inliner (14) and the carrier band (23).

8. The method as claimed in claim 6 or 7, characterized in that the carrier band (23) is brought to lie against the inside wall (3) by the inliner (14), but is not adhesively bonded to the inside wall (3).

9. The method as claimed in claim 8, characterized in that the carrier band (23) has on its side intended for lying against the inside wall (3) a layer (30) which is impermeable to the adhesive composition (22).

10. The method as claimed in one of the preceding claims, characterized in that the object to be laid (2) is provided with an adhesive composition (22), which is preferably a water-resistant synthetic resin, particularly preferably an epoxy resin, polyester resin or vinyl resin.

11. The method as claimed in one of the preceding claims, characterized in that the adhesive composition (22) is located on the outer side of the inverted inliner (14) and comes into contact with the object to be laid (2) when the inliner (14) inverts, the object to be laid (2) preferably only being provided with adhesive composition (22) by the inliner (14).

12. A device for carrying out the method as claimed in one of the preceding claims, with an adjustable guiding device (5), by means of which the laying of the object to be laid (2) can be specifically controlled in the longitudinal and transverse directions of the conduit pipe (4).

13. The device as claimed in claim 12, characterized by means for maintaining a defined minimum distance from the inliner arranged in the conduit pipe.

14. The device as claimed in one of claims 12 to 14, characterized in that the guiding device (5) has a guiding element (6) which can pivot and/or swivel and is capable of directing the object to be laid (2) in a slide-like manner tangentially to the inside wall (3) of the conduit pipe (4) or a branch pipe (25), the guiding element (6) is preferably in the form of a swan's neck.

15. The device as claimed in one of claims 12-15, characterized in that the guiding device (5) is fastened to an installation carriage (11) which can travel in the conduit pipe and preferably has a central lead-through (13) for the object to be laid (2).

16. The device as claimed in one of claims 12-15, characterized by a spacer (20), against which the inliner (14) butts during its movement and moves the device in the working direction.

17. The device as claimed in claim 16, characterized in that the guiding device (5) projects beyond the installation carriage on the rear side (19) of the latter, directed counter to the working direction, the spacer (20) preferably being arranged underneath the guiding device (5).

18. The device as claimed in one of claims 12-17, characterized by a control device (32), which is capable of measuring the distance from the inliner (14) and initiating a corresponding movement of the guiding device (5) or of the installation carriage (11), the control device (32) preferably comprising a contactlessly operating distance sensor (32′).
